(19) United States
(12) Patent Application Publication
(10) Pub. No.: US 2020/0193335 A1
(43) Pub. Date: Jun. 18, 2020

(54) SEAMLESS MANAGEMENT OF CONNECTED ENVIRONMENTS

(71) Applicant: Accenture Global Solutions Limited, Dublin (IE)

(72) Inventors: Mohan SEKHAR, Bangalore (IN); Prabir GHOUSHALKUMAR, Bangalore (IN); Bibin GEORGE, Bangalore (IN); Yesudas Bernard SHET, Bangalore (IN); Mainak BASU, Bangalore (IN)

(21) Appl. No.: 16/259,337

(22) Filed: Jan. 28, 2019

(30) Foreign Application Priority Data
Dec. 13, 2018 (IN) 201841047181

(51) Int. Cl. G06Q 10/02; G06Q 30/02

(52) U.S. Cl. CPC G06Q 10/025; G06Q 30/0282

(57) ABSTRACT

A tour management platform may determine, based on one or more sensors associated with a vehicle, that a user has boarded the vehicle, and may provide, based on determining that the user has boarded the vehicle, a first instruction to present, to the user, information associated with a tour service of a facility. The information associated with the tour service may include information identifying an agenda for presenting, to the user, a first plurality of content exhibits associated with the tour service. The tour management platform may detect an event associated with the tour service; may generate, based on detecting the event, a revised agenda for presenting, to the user, a second plurality of content exhibits associated with the tour service; and may provide, based on the revised agenda, a second instruction to present, to the user, a content exhibit of a second plurality of content exhibits.

### RELATED APPLICATION

This application claims priority under 35 U.S.C. § 119 to Indian Patent Application No. 201841047181, filed on Dec. 13, 2018, the content of which is incorporated by reference herein in its entirety.

### BACKGROUND

An entity, such as an enterprise, a learning institution, and/or the like, may be associated with one or more facilities in various geographic locations. In some cases, a facility may include a collection of geographically proximate environments, such as one or more buildings, one or more outdoor spaces, and/or the like.

### SUMMARY

According to some implementations, a tour management platform may include one or more memories, and one or more processors, communicatively coupled to the one or more memories, to determine, based on one or more sensors associated with a vehicle, that a user has boarded the vehicle. The one or more processors may provide, based on determining that the user has boarded the vehicle, a first instruction to present, to the user, information associated with a tour service of a facility, via at least one of one or more devices associated with the facility or one or more devices associated with the vehicle, wherein the information associated with the tour service comprises information identifying an agenda for presenting, to the user, a first plurality of content exhibits associated with the tour service. The one or more processors may detect an event associated with the tour service. The one or more processors may generate, based on detecting the event, a revised agenda for presenting, to the user, a second plurality of content exhibits associated with the tour service, wherein the revised agenda is generated based on a plurality of priority scores and wherein each priority score, of the plurality of priority scores, is associated with a respective content exhibit of the second plurality of content exhibits. The one or more processors may provide, based on the revised agenda, a second instruction to present, to the user, a content exhibit of the second plurality of content exhibits via at least one of the one or more devices associated with the facility or the one or more devices associated with the vehicle.

According to some implementations, a non-transitory computer-readable medium may store one or more instructions that, when executed by one or more processors of a tour management platform, cause the one or more processors to identify, based on one or more sensors associated with a vehicle, a user that has boarded the vehicle. The one or more instructions may cause the one or more processors to provide, based on identifying the user, a first instruction to present, to the user, information associated with a tour service of a facility, via one or more first devices associated with the vehicle, wherein the information associated with the tour service comprises information identifying an agenda for presenting, to the user, a first plurality of content exhibits associated with the tour service, and wherein the first plurality of content exhibits associated with the tour service is selected based on the user. The one or more instructions may cause the one or more processors to detect an event associated with the tour service. The one or more instructions may cause the one or more processors to generate, based on detecting the event, a revised agenda for presenting, to the user, a second plurality of content exhibits associated with the tour service, wherein the revised agenda is generated based on a plurality of priority scores, and wherein each priority score, of the plurality of priority scores, is associated with a respective content exhibit of the second plurality of content exhibits. The one or more instructions may cause the one or more processors to provide, based on the revised agenda, a second instruction to present, to the user and via the one or more first devices associated with the vehicle, a content exhibit of the second plurality of content exhibits. The one or more instructions may cause the one or more processors to provide, based on the revised agenda, a third instruction to present, to the user and via one or more second devices associated with a building included in the facility, one or more content elements associated with the tour service.

According to some implementations, a method may include determining, by a tour management platform and based on one or more sensors associated with a vehicle, that a user has boarded the vehicle. The method may include providing, by the tour management platform and based on determining that the user has boarded the vehicle, a first instruction to present, to the user, information associated with a tour service, of a facility, via one or more first devices associated with the vehicle, wherein the information associated with the tour service comprises information identifying an agenda for presenting, to the user, a first plurality of content exhibits associated with the tour service, and wherein the first plurality of content exhibits associated with the tour service is selected based on an attribute associated with the user. The method may include detecting, by the tour management platform, an event associated with the tour service. The method may include generating, by the tour management platform and based on detecting the event, a revised agenda for presenting, to the user, a second plurality of content exhibits associated with the tour service, wherein the revised agenda is generated based on a plurality of priority scores, and wherein each priority score, of the plurality of priority scores, is associated with a respective content exhibit of the second plurality of content exhibits. The method may include providing, by the tour management platform based on the revised agenda, a second instruction to present, to the user and via the one or more first devices associated with the vehicle, a content exhibit of the second plurality of content exhibits. The method may include providing, by the tour management platform and based on the revised agenda, a third instruction to present, to the user and via one or more second devices associated with a building included in the facility, the content exhibit of the second plurality of content exhibits.

### BRIEF DESCRIPTION OF THE DRAWINGS

FIGS. 1A-1H are diagrams of an example implementation described herein.

FIG. 2 is a diagram of an example environment in which systems and/or methods described herein may be implemented.

FIG. 3 is a diagram of example components of one or more devices of FIG. 2.

FIG. 4 is a diagram of an example tour management platform of FIG. 2.

FIGS. 5-7 are flow charts of example processes for seamless management of connected environments.

### DETAILED DESCRIPTION

The following detailed description of example implementations refers to the accompanying drawings. The same reference numbers in different drawings may identify the same or similar elements.

In some cases, a user may visit a facility to tour the facility, to attend a meeting at the facility, and/or the like. In some cases, the environments included in the facility may provide a fixed and/or static experience in that each environment may provide the user with a set of devices that is not able to communicate with another set of devices in another environment. As a result, the user's experience at the facility may be disjointed, in that there may not be a smooth transition in the user's experience from a first set of devices in a first environment to a second set of devices in a second environment. For example, processing and/or memory resources may be unnecessarily consumed because the user may need to reinitiate the user's experience every time the user transitions to another environment in the facility. As another example, processing and/or memory resources may be wasted on presenting content exhibits when there is not anyone nearby to view the content exhibits (e.g., because the user has left the vicinity of where a content exhibit is being presented), may be wasted on presenting content exhibits to the user in which the user has no interest, may be wasted on presenting content exhibits which conflict with the user's schedule, may be wasted on presenting content exhibits which conflict with other exhibits, and/or the like.

In addition, if an agenda of a tour service of the facility, provided to the user, is modified (e.g., before the tour service commences and/or during the tour service), the modification may have to be manually propagated to the various environments and personnel located at the facility (or not propagated at all), which can cause the tour service to become delayed, may cause unnecessary consumption of memory, processing, and/or networking resources of devices that are used to provide the tour service (e.g., content exhibits, included in the tour service, may be presented when the user is not actually present to view the content exhibits), may cause the utilization of the devices that are used to provide the tour service to be inefficiently scheduled, may cause unnecessary consumption of heating and cooling utilities at the facility (e.g., due to environments, in the facility, in which the tour service is to be provided being heated and/or cooled when the user is not present), and/or the like.

Some implementations, described herein, provide a tour management platform that is capable of providing seamless management of connected environments included in a facility, capable of providing a personalized tour service of the facility, and/or the like. The tour management platform may engage with a user that is to be provided a tour service at the facility, the moment the user boards a vehicle associated with the facility. Once the user has boarded the vehicle, the tour management platform may provide the user with a seamless experience as the user travels throughout the various environments in facility.

As the tour service is provided to the user, the tour management platform is capable of optimizing the agenda for the tour service of the facility and ensuring that the various environments and personnel at the facility are kept up to date on changes to the agenda. In this way, the tour management platform may detect an event associated with the tour service, may generate a revised agenda for the tour service and may provide the revised agenda to various devices associated with the facility and/or vehicles that transport the user throughout the facility. This reduces the consumption of processing resources, memory resources, networking resources, and/or building resources (e.g., electricity, heating and cooling, and/or the like) by reducing and/or preventing content exhibits from being presented when there is not anyone nearby to view the content exhibits, by reducing and/or preventing content exhibits from being presented to the user in which the user has no interest, by reducing and/or preventing content exhibits from being presented to the user which conflict with the user's schedule, by reducing and/or preventing content exhibits from being presented which conflict with other exhibits, and/or the like.

In addition, the tour management platform is capable of providing a more tailored and user-centric experience by ensuring that the content exhibits included in the agenda of the tour service that is to be provided to the user are relevant and of high value/interest to the user. In this way, several different stages of the process for generating and/or revising the agenda are automated, which may remove human subjectivity and waste from the process, and which may improve speed and efficiency of the process and conserve computing resources (e.g., processor resources, memory resources, and/or the like). Moreover, in this way, the tour management platform may use a rigorous, computerized process to perform tasks or roles that were not previously performed or were previously performed using subjective human intuition or input, such as generating priority scores for content exhibits based on artificial intelligence and/or machine learning.

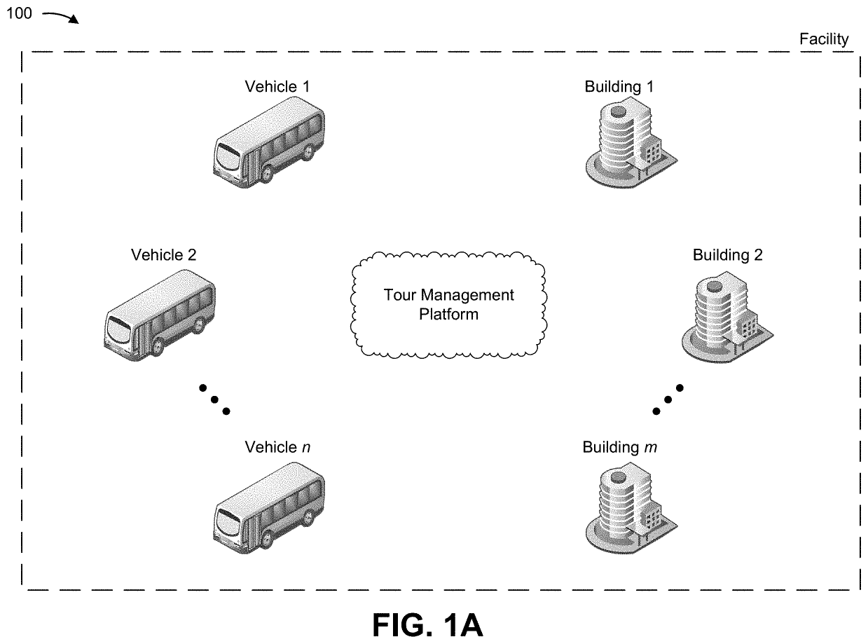

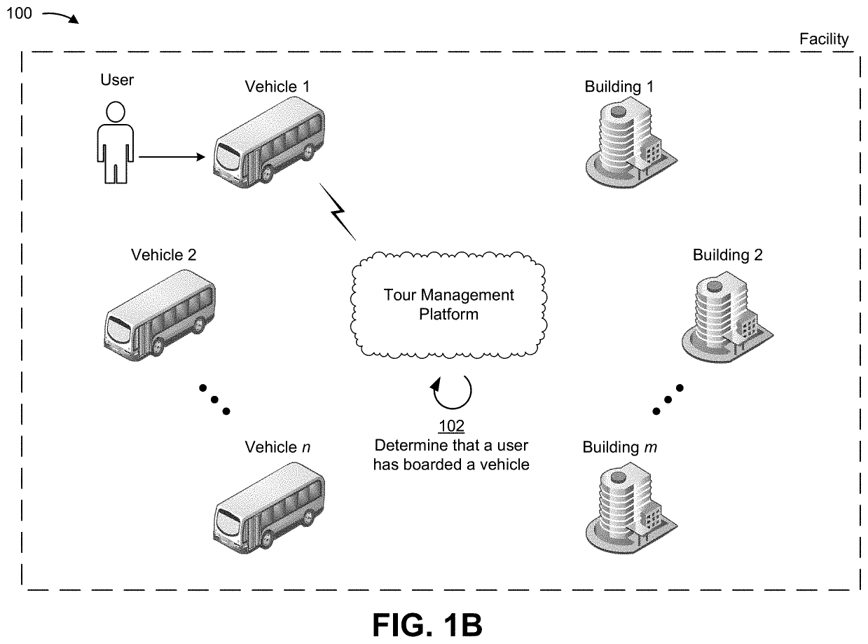

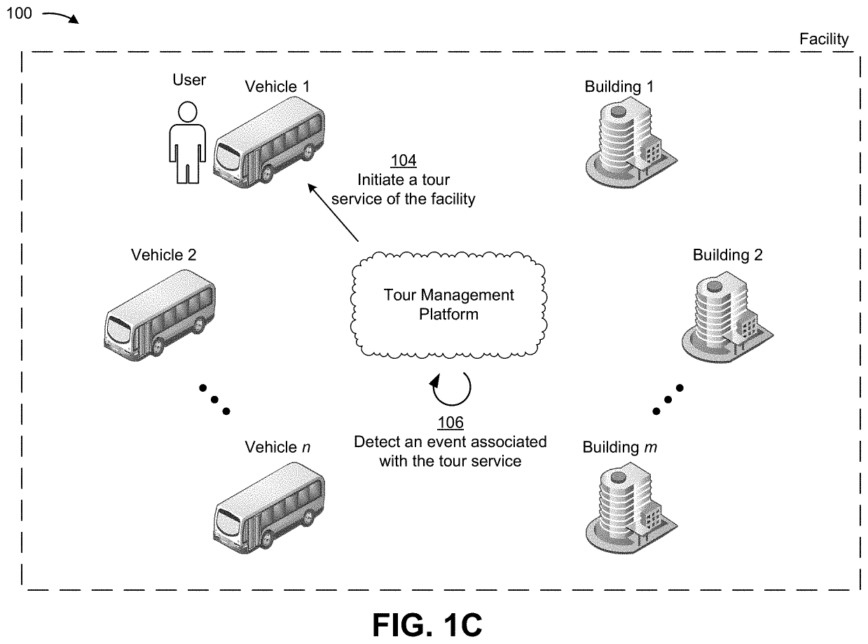

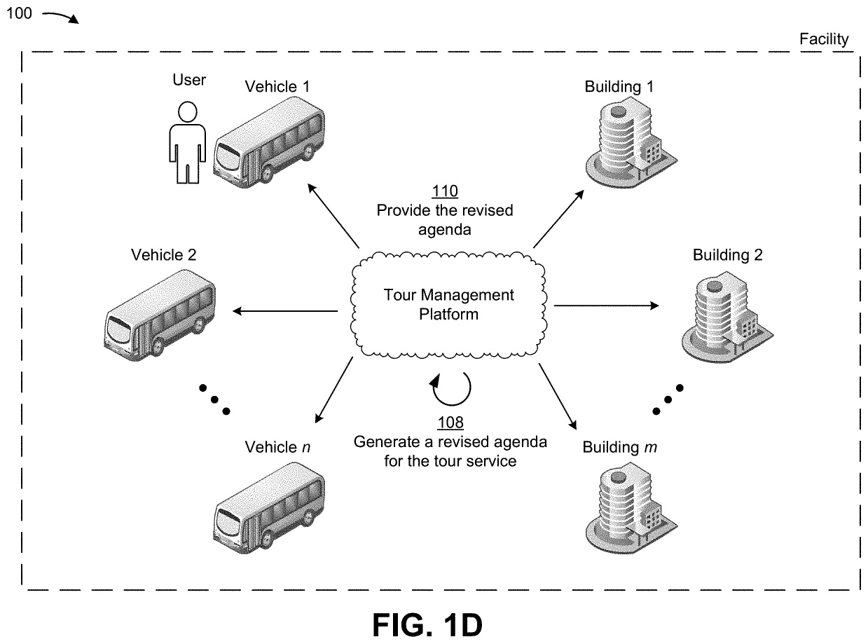

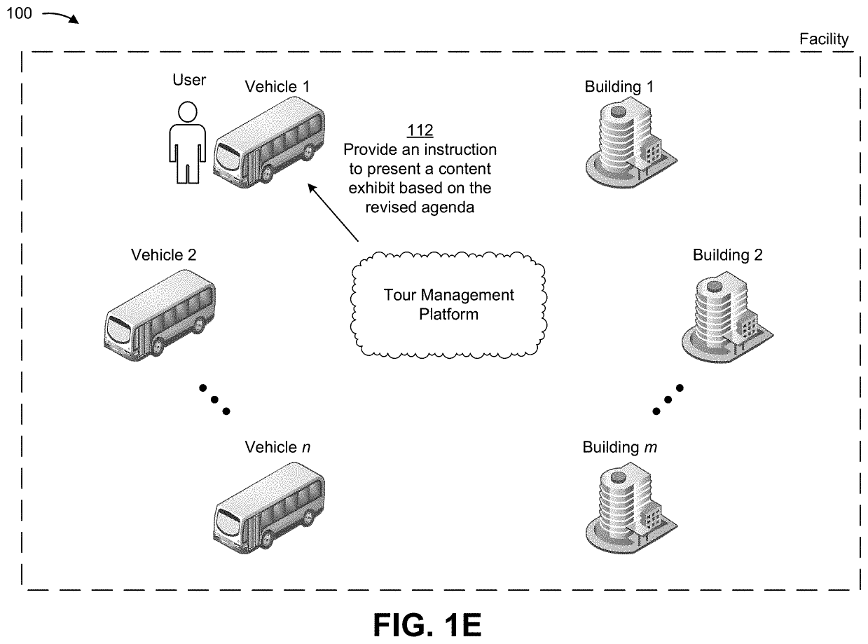

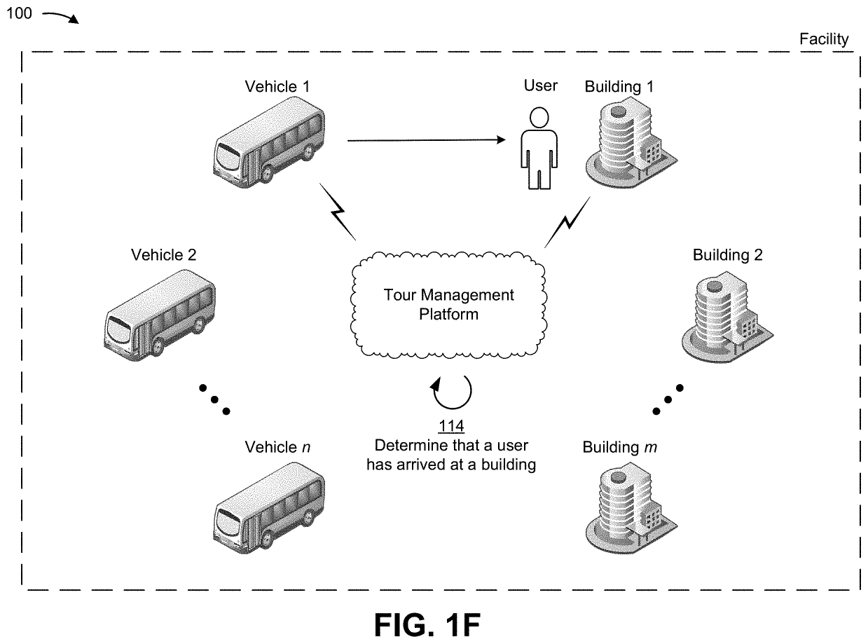

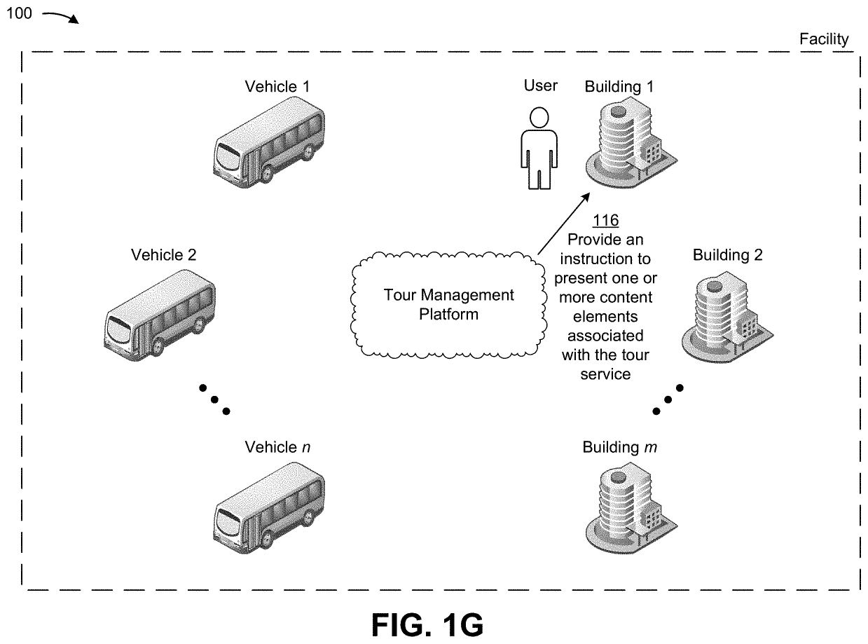

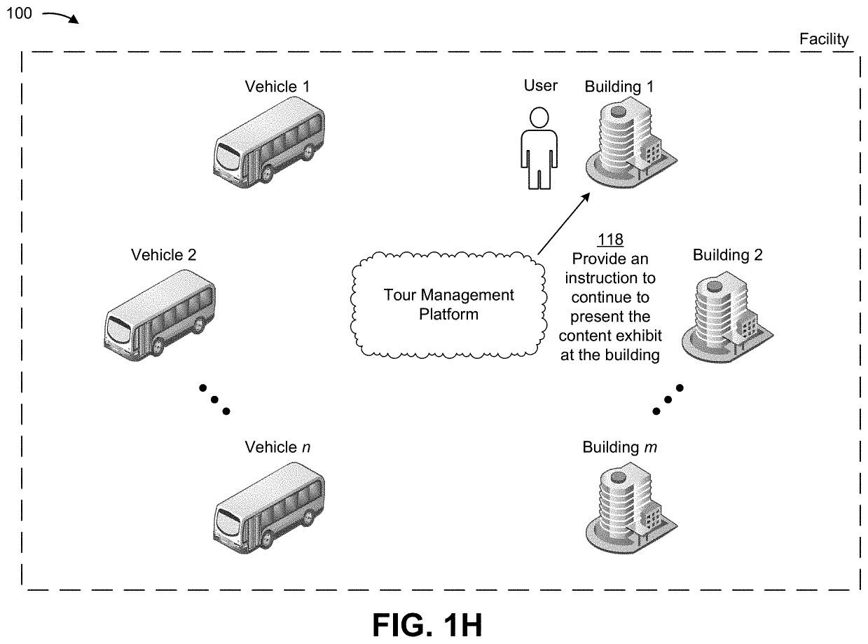

FIGS. 1A-1H are diagrams of an example implementation 100 described herein. As shown in FIG. 1A, implementation 100 may include a facility that includes various environments, such one or more buildings (e.g., building 1 through building m, individually referred to as “building” and collectively referred to as “buildings”), one or more outdoor environments, and/or the like. As further shown in FIG. 1A, implementation 100 may include one or more vehicles (e.g., vehicle 1 through vehicle n, individually referred to as “vehicle” and collectively referred to as “vehicles”) that are capable of transporting users to, from, and around the facility, may include a tour management platform, and/or the like.

In some implementations, the facility and vehicles may include various sensor devices and input/output (I/O) devices, and/or the like. In some implementations, the sensor devices and I/O devices may be communicatively connected with the tour management platform and may provide information to, and/or receive information from, the tour management platform.

In some implementations, the information may be associated with a user that is touring the facility, may be associated with a tour service that is to be provided to the user at the facility, may be associated with the facility, may be associated with the vehicles, and/or the like.

In some implementations, a sensor device may include one or more devices that collect and provide information associated with movement of the user at the facility, such as the user arriving at the facility, the user entering and/or exiting a vehicle associated with the facility, the user entering and/or exiting a building included in the facility, the user moving to different locations within a building, and/or the like. In some implementations, a sensor device may collect and provide information associated with the identity of the user, such as biometric information (e.g., a hand scan, a fingerprint scan, a facial scan, a retina scan, gait scan, and/or the like) and/or the like. In some implementations, a sensor device may collect and provide information associated with climate conditions at and/or near the facility (e.g., within a threshold distance of the facility, such as a one-mile radius, a five-mile radius, and/or the like), such as temperature information, humidity information, rainfall information, snowfall information, storm information, and/or the like. In some implementations, a sensor device may collect and/or provide traffic information at or near the facility, such as traffic volume, expected travel times (e.g., between buildings included in the facility, from the user's location to a building included in the facility, and/or the like), traffic delays, and/or the like.

In some implementations, an I/O device may receive and provide inputs from the user (e.g., keyboard inputs, mouse inputs, touchscreen inputs, smart whiteboard inputs, voice commands, gestures, and/or the like). In some implementations, an I/O device may generate and provide video recordings, audio recordings, streaming video, streaming audio, and/or the like. In some implementations, an I/O device may display content to the user (e.g., video recordings, interactive video content, and/or the like), may play audio content to the user, may provide a graphical user interface with which the user may interact, and/or the like.

In some implementations, the sensor devices and I/O devices may be located throughout the facility and/or vehicles to provide various connected environments at the facility. For example, the vehicles may include one or more sensor devices and/or one or more I/O devices that may communicate (e.g., directly communicate, indirectly communicate through the tour management platform, and/or the like) with one or more sensor devices and/or I/O devices located at a building included in the facility and vice-versa. In this way, information that is generated or modified in a particular connected environment may be provided to other connected environments, content that is presented in a particular environment may be seamlessly transitioned to another connected environment as a user to whom the content is presented moves throughout the facility, and/or the like.

In some implementations, the tour management platform may manage a tour service that is to be provided to a user that tours the facility, may manage the various connected environments included in the facility, and/or the like. A tour service of the facility may include a curated and/or an arranged tour of the facility. The tour may include a guided tour (e.g., a tour where personnel at the facility personally guide the user through the tour, a tour where a virtual assistant and/or another virtual entity guides the user through the tour, and/or the like), may include an unguided tour (e.g., a tour where the user experiences the facility without the assistance of a guide), and/or the like. A tour service may include a plurality of content exhibits. A content exhibit may include electronic content, in-person content, mixed reality content, and/or the like, that is to be presented to the user during the tour of the facility, that the user may interact with during the tour of the facility, and/or the like. A content exhibit may include audio content (e.g., an audio recording on a particular topic, a live audio lecture, and/or the like), video content (e.g., a two-dimensional video stream or video recording, a three-dimensional video stream or video content recording, an augmented reality video stream or video recording, a virtual reality video stream or video recording, and/or the like), a product demonstration, an in-person presentation, an instructor-led training course, a tour of a particular aspect of the facility (e.g., a datacenter tour, a factory tour, and/or the like), an interactive content display (e.g., interactive virtual reality content, interactive whiteboard content, and/or the like), web-based content (e.g., text, images, web-based training courses, and/or the like), and/or the like.

To manage a tour service of the facility, the tour management platform may generate an agenda for the tour service, may modify the agenda for the tour service, may communicate information associated with the tour service to the various connected environments and I/O devices included therein, and/or the like. An agenda for a tour service of the facility may include information identifying one or more content exhibits that are to be presented to the user during the user's tour to the facility, may include information identifying an order in which the one or more content exhibits are to be presented to the user, may include information identifying a location at which a particular content exhibit is to be presented to the user (e.g., a particular building included in the facility, a particular room in a building, and/or the like), may include information identifying a time duration of a particular content exhibit (e.g., a proposed amount of time the user is to spend viewing the content exhibit), and/or the like.

In some implementations, the tour management platform may automatically generate the agenda for the tour service. For example, the tour management platform may automatically determine which content exhibits to include in the tour service based on input provided by the user (e.g., an input specifying one or more content exhibits the user wants to be presented during the tour service, an input specifying one or more content exhibits the user does not want to be presented during the tour service, and/or the like), based on one or more attributes associated with the user (e.g., based on an industry in which the user works, based on an entity to which the user is associated, and/or the like), based on the outcomes of tour services provided to other users that are similar to the user (e.g., other users that are associated with the same and/or similar industries and/or entities), based on an expected time duration of the tour service, and/or the like. In this way, the tour management platform is capable of providing a customized and personalized tour service that is tailored to the user.

In some implementations, the tour management platform may further optimize the agenda for the tour service by identifying a plurality of content exhibits, generating a priority score for each content exhibit of the plurality of content exhibits, and selecting the content exhibits, of the plurality of content exhibits, that are to be included in the tour service based on the priority scores for the plurality of content exhibits and the expected time duration for the tour service. In some implementations, the priority score, for a particular content exhibit, may represent the importance of the content exhibit to the user and/or the one or more attributes of the user, relevance of the content exhibit to the user and/or the one or more attributes of the user, and/or likelihood that the user will have a positive experience with the content exhibit. The tour management platform may select the content exhibits, that are to be included in the tour service, based on a priority score threshold (e.g., 90% priority score, 95% priority score, and/or the like), based on descending priority scores (e.g., until the expected time duration of the tour service is filled), and/or the like.

In some implementations, the tour management platform may generate a priority score for a particular content exhibit, based on an amount of time that other users with similar attributes spent viewing the content exhibit, based on a quantity of other users with similar attributes that have viewed the content exhibit, based on a quantity of other users with similar attributes that expressed an interest in viewing the content exhibit, based on feedback from other users with similar attributes that have viewed the content exhibit, based on the user's preference for the content exhibit, based on feedback received from the user for a past viewing of the content exhibit in another tour service, based on an analysis of emotions of the user as the user viewed the content exhibit in the other tour service, based on a relevancy of the content exhibit to the user and/or the user's attributes, and/or the like. In some implementations, the tour management platform may use artificial intelligence and/or a machine learning algorithm (e.g., a linear regression algorithm, a neural network algorithm, a naïve Bayes algorithm, and/or the like) to train (e.g., supervised, unsupervised, semi-supervised, and/or the like) on the various types of information for the content exhibit described above, and to generate the priority score for the content exhibit based on the user and/or the one or more attributes associated with the user.

Turning to FIG. 1B, to initiate the tour service of the facility, the user may travel to a location at or near the facility so that the user may board a vehicle (e.g., vehicle 1 as shown in FIG. 1B) associated with the facility. As shown by reference number 102, the tour management platform may determine that the user has boarded the vehicle. In some implementations, the tour management platform may determine that the user has boarded the vehicle based on the sensors located in and/or near the vehicle. For example, the user may be instructed to provide biometric information associated with the user, such as a hand scan, a fingerprint scan, and/or the like, and the sensors located in and/or near the vehicle may provide the biometric information to the tour management platform so that the tour management platform may use the biometric information to verify the identity of the user and determine that the user has boarded the vehicle. As another example, the user may be instructed to scan a badge and/or another type of identification card associated with the user, and the tour management platform may use the scan to verify the identity of the user and determine that the user has boarded the vehicle. In some implementations, the tour management platform may determine that the user has boarded the vehicle based on the I/O devices located in and/or near the vehicle, based on a user device associated with the user, and/or the like. For example, the user may use an I/O device or the user device to sign in to a web-based and/or software-based tour management portal and/or the like.

As shown in FIG. 1C, and by reference number 104, the tour management platform may initiate the tour of the facility based on determining that the user has boarded the vehicle. To initiate the tour of the facility, the tour management platform may perform various actions. In some implementations, the tour management platform may provide, to the vehicle, an instruction to present (e.g., in visual form, in audio form, and/or the like), via the I/O devices included in the vehicle, the agenda for the tour service, an instruction to present a welcome communication for the facility, an instruction to present a content exhibit included in the tour service, an instruction to provide, via the I/O devices included in the vehicle, the user with a collaborative electronic environment in which the user may provide input associated with the tour service and/or input associated with the presented content exhibit, and/or the like.

In some implementations, when presenting the agenda, the welcome communication, the collaborative environment, and/or the like, the tour management platform may determine the type of I/O device and/or user device (e.g., handheld device such as a tablet or smartphone, an augmented reality device, a virtual reality device, a display screen, and/or the like) on which the agenda, the welcome communication, the collaborative environment, and/or the like is to be presented. For example, the tour management platform may determine the type of I/O device and/or user device based on user preference (e.g., based on input, received from the user, that indicates the user prefers to use a handheld device when in the vehicle), based on the type of content that is to be presented to the user (e.g., based on the welcome communication being an audio communication), and/or the like.

In some implementations, when initiating the tour service, the tour management platform may provide, to the vehicle, an instruction to automatically and/or autonomously travel to a particular location, such as a building located at the facility, an outdoor environment located at the facility, and/or the like. For example, the tour management platform may determine, based on the agenda for the tour service, that the next content exhibit, to be presented to the user, is located at building 1, and accordingly may provide an instruction to vehicle 1 to travel to building 1.

In some implementations, when initiating the tour service, the tour management platform may provide, to the vehicle, an instruction to automatically present a content exhibit to the user. For example, the tour management platform may determine that a content exhibit, included in the tour service, is capable of being presented to the user while the user is onboard the vehicle, and accordingly may provide an instruction to present the content exhibit to the user while the user is onboard the vehicle.

As further shown in FIG. 1C, and by reference number 106, the tour management platform may detect an event associated with the tour service. The event may include various types of events associated with the user, associated with the facility, associated with a content exhibit, and/or the like. For example, an event associated with the user may include the user arriving to the facility at a time that is later than a planned arrival time of the user. As another example, an event associated with the user may include the tour management platform receiving a user input that specifies a particular change to the tour service, such as a user input that indicates that the user does not want to be presented a particular content exhibit that is included in the agenda of the tour service, a user input that indicates that the user wants to be presented a particular content exhibit that is not included in the agenda for the tour service, a user input that indicates that the user wants to increase or decrease the time duration of the tour service, a user input that indicates that the user wants to increase or decrease a time duration of a particular content exhibit, a user input that indicates that the user wants a particular content exhibit to be presented to the user earlier or later in the tour service, a user input that indicates that the user wants a particular content exhibit to be presented to the user in a different format, and/or the like.

As another example, an event associated with the user may include the tour management platform determining that the user's experience with a particular content exhibit is not a positive experience. For example, the tour management platform may monitor various behavior characteristics of the user (e.g., facial expressions, posture, and/or the like) to determine that the user is not responding positively to the content exhibit. As another example, the tour management platform may receive input from the user (e.g., text input, audio input, and/or the like), that indicates that the user's experience with the content exhibit is not positive.

In some implementations, an event associated with the facility may include a delay in travel of a vehicle to a building included in the facility. For example, a vehicle may be scheduled to transport the user to a particular building for a scheduled content exhibit, and the vehicle may become delayed (e.g., due to traffic, due to unplanned maintained of the vehicle, due to weather at the facility, and/or the like). In some implementations, an event associated with the facility may include a weather event (e.g., rain, a snow storm, a thunderstorm, a tornado, and/or the like) within a threshold distance of the facility, an unplanned interruption, such as an earthquake, a fire, a riot, and/or the like.

In some implementations, an event associated with a content exhibit may include the content exhibit being unavailable to be presented to the user during the tour service, may include the content exhibit being unavailable to be presented to the user in a particular format, may include the content exhibit being unavailable to be presented to the user at a particular location in the facility, and/or the like.

As shown in FIG. 1D, and by reference number 108, the tour management platform may generate a revised agenda for the tour service based on detecting the event. In some implementations, the revised agenda may be different from the agenda in that the revised agenda may include a different order in which content exhibits are to be presented to the user, may include a content exhibit that was not included in the agenda, may not include a content exhibit that was included in the agenda, may include a content exhibit that is to be presented to the user in a different format, may include a content exhibit that is to be presented in a greater time duration, may include a content exhibit that is to be presented in a smaller time duration, and/or the like.

In some implementations, the tour management platform may generate the revised agenda based on various factors, such as the detected event, the priority score associated with each content exhibit (e.g., each content exhibit included in the agenda, each content exhibit included in the revised agenda, and/or the like), and/or the like. For example, the tour management platform may generate the revised agenda such that the revised agenda includes a content exhibit, that was not included in the agenda, specified in an input provided by the user. As another example, the tour management platform may generate the revised agenda such that the revised agenda does not include a content exhibit, that was included in the agenda, based on the time duration of the tour service being reduced due to the event. In this case, the tour management platform may exclude the content exhibit as a result of increasing the priority score threshold (e.g., and thus determining that the priority score, associated with the excluded content exhibit, does not meet the increased priority score threshold), as a result of the priority score associated with the excluded content exhibit being the lowest priority score in the agenda, and/or the like. In some implementations, the tour management platform may determine the time duration of the tour service, as a result of the event, based on the weather event within the threshold distance of the facility, based on expected travel times between buildings in the facility, based on an estimated arrival time of the user at the facility, based on traffic at the facility and/or within a threshold distance of the facility, and/or the like.

In some implementations, instead of excluding a content exhibit from the revised agenda, the tour management platform may specify that the content exhibit is to be presented in a different format. For example, the tour management platform may specify, in the revised agenda, that the content exhibit is to be presented in an audio recording, whereas in the agenda, the content exhibit was to be presented in a live lecture format. In this way, the tour management platform may ensure that the shortened time duration of the tour service is efficiently utilized such that the content exhibit can still be presented to the user (e.g., while the user is traveling on a vehicle between buildings in the facility).

As further shown in FIG. 1D, and by reference 110, the tour management platform may provide the revised agenda to the various environments and/or vehicles. In some implementations, the tour management platform may further provide information associated with the event that resulted in the revised agenda. In this way, personnel around the facility may be automatically informed of changes to the tour service, and various automated actions may be performed; for example, an autonomous travel schedule associated with the vehicles may be revised based on the revised agenda, signage around the facility and/or in the vehicles may be changed based on the revised agenda, buildings may be locked and/or unlocked for the user based on the revised agenda, weather-related structures and/or devices may be deployed based on the information associated with the event (e.g., umbrellas and/or awnings may be deployed based on the event being a thunderstorm), and/or the like.

As shown in FIG. 1E, and by reference number 112, the tour management platform may provide an instruction, to various devices associated with the facility and/or the vehicles, to present a content exhibit to the user based on the revised agenda. For example, the tour management platform may determine the user's location based on the sensors located throughout the facility and/or the vehicles, and may provide the instruction to one or more devices near the user's location. In the example illustrated in FIG. 1E, the user may be on board vehicle 1, and accordingly the tour management platform may provide the instruction to the I/O devices included in vehicle 1.

In this way, the tour management platform is capable of optimizing the agenda (and the revised agenda) for the tour service of the facility and ensuring that the various environments and personnel at the facility are kept up to date on changes to the agenda. In this way, tour management platform may detect the event associated with the tour service, may generate the revised agenda for the tour service, and may provide the revised agenda to the various devices associated with the facility and/or the vehicles, and/or the like, which reduces the consumption of processing resources, memory resources, networking resources, and/or building resources (e.g., electricity, heating and cooling, and/or the like) by reducing and/or preventing content exhibits from being presented when there is not anyone nearby to view the content exhibits, by reducing and/or preventing content exhibits from being presented to the user in which the user has no interest, by reducing and/or preventing content exhibits from being presented to the user which conflict with the user's schedule, by reducing and/or preventing content exhibits from being presented which conflict with other exhibits, and/or the like.

Moreover, in this way, the tour management platform is capable of providing a more tailored and user-centric experience by ensuring that the content exhibits, included in the agenda and revised agenda, are relevant and of high value to the user. In this way, several different stages of the process for generating and/or revising the agenda are automated, which may remove human subjectivity and waste from the process, and which may improve speed and efficiency of the process and conserve computing resources (e.g., processor resources, memory resources, and/or the like). Moreover, in this way, the tour management platform may use a rigorous, computerized process to perform tasks or roles that were not previously performed or were previously performed using subjective human intuition or input, such as generating priority scores for content exhibits based on artificial intelligence and/or machine learning.

Turning to FIG. 1F, the tour management platform may further manage the tour service as the user moves throughout the facility by providing seamless connectivity between the various environments included in the facility. As shown by reference number 114, the tour management platform may determine, based on monitoring the movement of the user throughout the facility, that the user has arrived at a building (e.g., building 1). In some implementations, the tour management platform may determine that the user has arrived at the building based on the location of the user device associated with the user, based on the location of the vehicle on which the user was traveling (e.g., vehicle 1), based on detecting the user's presence at the building (e.g., based on sensors located at building 1), and/or the like.

As shown by FIG. 1G, the tour management platform may perform various actions based on determining that the user has arrived at the building. For example, the tour management platform may provide, to the building, an instruction to automatically unlock a door so that the user may enter the building, an instruction to automatically turn on one or more lights associated with the building, and/or the like. As shown by reference number 116, the tour management platform may provide, to the building and based on determining that the user has arrived at the building, an instruction to automatically present one or more content elements, associated with the tour service, via the I/O devices associated with the building. The one or more content elements may include an audio welcome message that greets the user as the user enters the building, may include a video presentation that provides the user with directions to a location, in the building, at which the user is to travel, and/or the like.

As shown in FIG. 1H, and by reference number 118, the tour management platform may provide, to the building, an instruction to continue to present, based on the revised agenda, a content exhibit to the user. In some implementations, to provide a seamless experience of the tour service, the tour management platform may determine that the user was viewing a content exhibit when the user arrived at the building, and accordingly may provide an instruction to continue to present the content exhibit at the building. In this way, the tour management platform may determine a point in the content exhibit at which the user exited the vehicle, and may provide, based on determining that the user has arrived at the building, a third instruction to initiate the presentation, of the content exhibit, at the point in the content exhibit at which the user exited the vehicle.

In this way, the tour management platform that is capable of providing seamless management of connected environments included in the facility, and using the connected environments to providing a seamless and personalized tour service of the facility. In this way, the tour management platform may engage with the user the moment the user boards the vehicle associated with the facility, and may provide the user with a seamless experience as the user travels throughout the various environments in the facility.

As indicated above, FIGS. 1A-1H are provided merely as examples. Other examples may differ from what is described with regard to FIGS. 1A-1H.

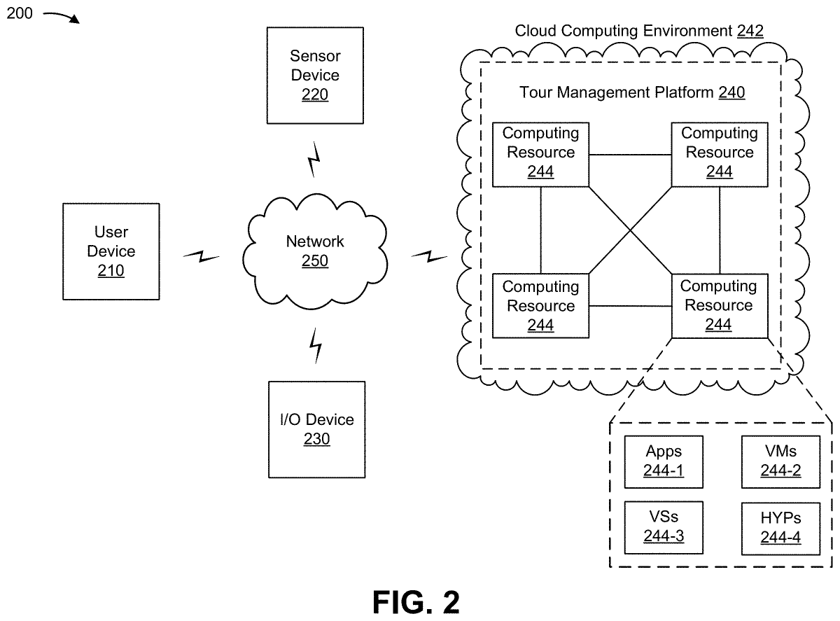

FIG. 2 is a diagram of an example environment 200 in which systems and/or methods described herein may be implemented. As shown in FIG. 2, environment 200 may include a user device 210, a sensor device 220, an I/O device 230, a tour management platform 240, a network 250, and/or the like. Devices of environment 200 may interconnect via wired connections, wireless connections, or a combination of wired and wireless connections.

User device 210 includes one or more devices capable of receiving, generating, storing, processing, and/or providing information, such as information described herein. For example, user device 210 may include a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), a desktop computer, or a similar type of device. In some implementations, user device 210 may be associated with a user that is to tour a facility, and may provide, to tour management platform 240, user information associated with the user; may receive, from tour management platform 240, an instruction to present a content exhibit associated with a tour service of the facility, and/or the like.

Sensor device 220 includes one or more devices capable of receiving, generating, storing, processing, and/or providing information, such as information described herein. For example, sensor device 220 may include a tag reader sensor device that may scan a radio frequency identifier (RFID) device, a Bluetooth device, and/or the like, associated with the user, and may provide, to tour management platform 240, information associated with the scan (e.g., a time of the scan, a date of the scan, a location of the scan, and/or the like), information associated with the user (e.g., a name of the user, an entity with which the user is associated, one or more attributes associated with the user, and/or the like), and/or the like. As another example, sensor 220 may include a biometric sensor that may scan a biometric aspect of the user (e.g., a finger print, a hand, a retina, a face, and/or the like) and may provide, to tour management platform 240, information associated with the scan, information associated with the user, and/or the like.

I/O device 230 includes one or more devices capable of receiving, generating, storing, processing, and/or providing information, such as information described herein. For example, I/O device 230 may include a display device (e.g., an augmented reality display device, a virtual reality display device, a two-dimensional display device, a four-dimensional display device, and/or the like), various types of input peripherals (e.g., a keyboard, a mouse, a touch screen, and/or the like), a speaker, and/or the like. In some implementations, I/O device 230 may present a content exhibit, associated with a tour service of a facility, to a user. In some implementations, I/O device 230 may receive inputs from the user and may provide the inputs to tour management platform 240.

Tour management platform 240 includes one or more devices capable of seamlessly managing connected environments and tour services of a facility in which the connected environments are included. For example, tour management platform 240 may include one or more devices capable of receiving information from user device 210, sensor device 220, I/O device 230, and/or the like; capable of generating an agenda and/or a revised agenda for a tour service of a facility; capable of providing instructions (e.g., to user device 210, to I/O device 230, and/or the like) to display content exhibits and/or content elements; and/or the like.

In some implementations, tour management platform 240 may be designed to be modular such that certain software components may be swapped in or out depending on a particular need. As such, tour management platform 240 may be easily and/or quickly reconfigured for different uses. In some implementations, tour management platform 240 may receive information from and/or transmit information to user device 210, sensor device 220, and/or I/O device 230.

In some implementations, as shown, tour management platform 240 may be hosted in a cloud computing environment 242. Notably, while implementations described herein describe tour management platform 240 as being hosted in cloud computing environment 242, in some implementations, tour management platform 240 may not be cloud-based (i.e., may be implemented outside of a cloud computing environment) or may be partially cloud-based. Cloud computing environment 242 includes an environment that hosts tour management platform 240. Cloud computing environment 242 may provide computation, software, data access, storage, etc. services that do not require end-user knowledge of a physical location and configuration of system(s) and/or device(s) that hosts tour management platform 240. As shown, cloud computing environment 242 may include a group of computing resources 234 (referred to collectively as “computing resources 244” and individually as “computing resource 244”).

Computing resource 244 includes one or more personal computers, workstation computers, server devices, or other types of computation and/or communication devices. In some implementations, computing resource 244 may host tour management platform 240. The cloud resources may include compute instances executing in computing resource 244, storage devices provided in computing resource 244, data transfer devices provided by computing resource 244, etc. In some implementations, computing resource 244 may communicate with other computing resources 234 via wired connections, wireless connections, or a combination of wired and wireless connections.

As further shown in FIG. 2, computing resource 244 includes a group of cloud resources, such as one or more applications (“APPs”) 244-1, one or more virtual machines (“VMs”) 244-2, virtualized storage (“VSs”) 244-3, one or more hypervisors (“HYPs”) 244-4, and/or the like.

Application 244-1 includes one or more software applications that may be provided to or accessed by user device 210, sensor device 220, and/or I/O device 230. Application 244-1 may eliminate a need to install and execute the software applications on user device 210, sensor device 220, and/or I/O device 230. For example, application 244-1 may include software associated with tour management platform 240 and/or any other software capable of being provided via cloud computing environment 242. In some implementations, one application 244-1 may send/receive information to/from one or more other applications 244-1, via virtual machine 244-2.

Virtual machine 244-2 includes a software implementation of a machine (e.g., a computer) that executes programs like a physical machine. Virtual machine 244-2 may be either a system virtual machine or a process virtual machine, depending upon use and degree of correspondence to any real machine by virtual machine 244-2. A system virtual machine may provide a complete system platform that supports execution of a complete operating system (“OS”). A process virtual machine may execute a single program, and may support a single process. In some implementations, virtual machine 244-2 may execute on behalf of a user (e.g., a user of user device 210 or an operator of tour management platform 240), and may manage infrastructure of cloud computing environment 242, such as data management, synchronization, or long-duration data transfers.

Virtualized storage 244-3 includes one or more storage systems and/or one or more devices that use virtualization techniques within the storage systems or devices of computing resource 244. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 244-4 may provide hardware virtualization techniques that allow multiple operating systems (e.g., “guest operating systems”) to execute concurrently on a host computer, such as computing resource 244. Hypervisor 244-4 may present a virtual operating platform to the guest operating systems, and may manage the execution of the guest operating systems. Multiple instances of a variety of operating systems may share virtualized hardware resources.

Network 250 includes one or more wired and/or wireless networks. For example, network 250 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

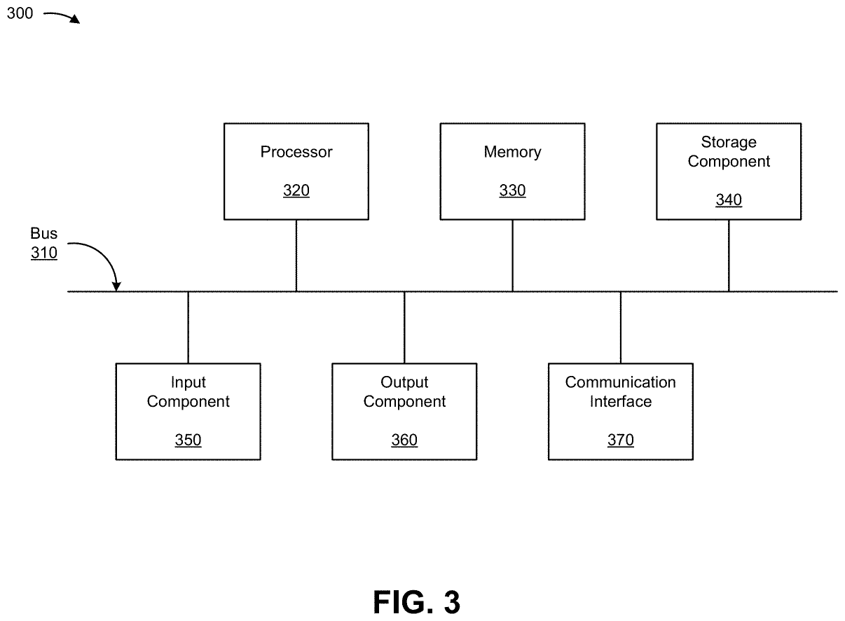

FIG. 3 is a diagram of example components of a device 300. Device 300 may correspond to user device 210, sensor device 220, I/O device 230, tour management platform 240, computing resource 244, and/or one or more devices included in network 250. In some implementations, user device 210, sensor device 220, I/O device 230, tour management platform 240, computing resource 244, and/or one or more devices included in network 250 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among components of device 300. Processor 320 is implemented in hardware, firmware, or a combination of hardware and software. Processor 320 takes the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

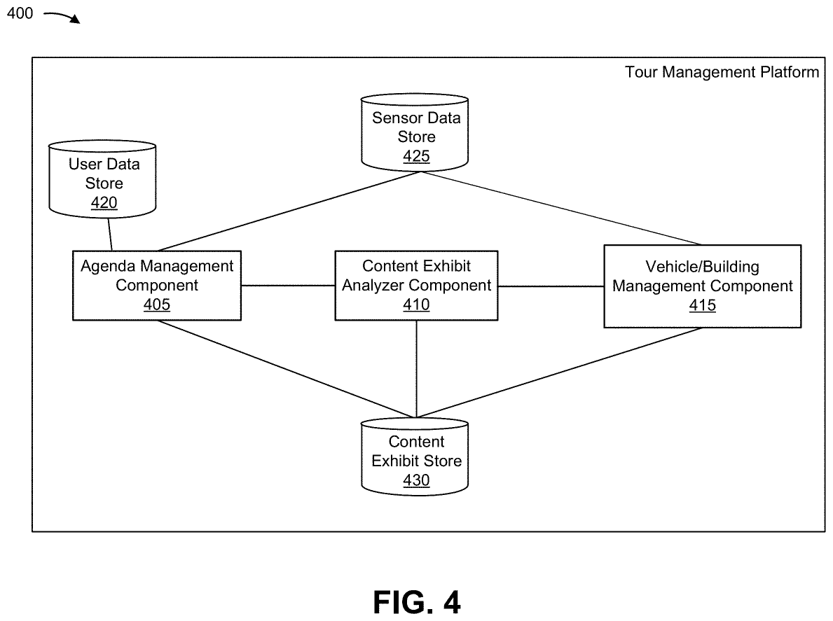

FIG. 4 is a diagram of an example tour management platform (e.g., tour management platform 400), as described herein. Tour management platform 400 may seamlessly manage connected environments and tour services of a facility in which the connected environments are included, as described herein. In some implementations, tour management platform 400 may be implemented by tour management platform 240 of FIG. 2, by device 300 of FIG. 3, and/or the like.

As shown in FIG. 4, tour management platform 400 may include various components, such as an agenda management component 405, a content exhibit analyzer component 410, a vehicle/building management component 415, a user data store 420, a sensor data store 425, a content exhibit store 430, and/or the like. In some implementations, the components included in FIG. 4 may be implemented by separate components and/or devices, may be included in the same component and/or device, and/or the like.

Agenda management component 405 may generate an agenda for a tour service of a facility, may generate a revised agenda for the tour service, and/or the like. For example, agenda management component 405 may generate the agenda and/or revised agenda, as described above in reference to FIGS. 1A-1H. In some implementations, agenda management component 405 may generate the agenda and/or revised agenda based on information associated with a user (e.g., stored in user data store 420), such as information identifying the user, information identifying one or more attributes associated with the user, and/or the like. In some implementations, agenda management component 405 may generate the agenda and/or revised agenda based on information (e.g., stored in sensor data store 425) collected by one or more sensors located around the facility and/or one or more vehicles associated with the facility, such as biometric information associated with the user, badge scans associated with the user, behavior characteristic information collected from the user (e.g., facial expressions, posture, and/or the like); weather information; traffic information; and/or the like. In some implementations, agenda management component 405 may generate the agenda and/or revised agenda based on content exhibit information (e.g., stored in content exhibit store 430), such as information identifying a plurality of content exhibits, information identifying priority scores associated with the plurality of content exhibits, and/or the like.

Content exhibit analyzer component 410 may generate the priority scores associated with the plurality of content exhibits and may store the priority scores in content exhibit store 430. For example, content exhibit analyzer component 410 may generate the priority scores associated with the plurality of content exhibits, as described above in reference to FIGS. 1A-1H.

Vehicle/building management component 415 may communicate with the one or more vehicles associated with the facility, may communicate with one or more buildings included in the facility, may provide communication between the one or more vehicles and/or the one or more buildings, and/or the like. For example, vehicle/building management component 415 may receive sensor data from various sensors located in the facility and/or located in the one or more vehicles, and may store the sensor data in sensor data store 425. As another example, vehicle/building management component 415 may provide various instructions to the one or more vehicles and/or the one or more buildings, such as an instruction for a vehicle to autonomously travel to a particular building included in the facility, an instruction to present a content exhibit to the user, an instruction to present a content element to the user, and/or the like. In some implementations, vehicle/building management component 415 may provide an agenda and/or a revised agenda (or portions thereof), associated with a tour service of the facility, to the one or more vehicles and/or the one or more buildings included in the facility.

User data store 420, sensor data store 425, and content exhibit store 430 may include various types of data stores, such as an electronic data structure (e.g., an electronic file, an electronic file system, an electronic database, and/or the like), a physical and/or virtual storage device (e.g., a memory device, storage drive, and/or the like), and/or the like. In some implementations, user data store 420, sensor data store 425, and/or content exhibit store 430 may be included in the same data store, may be included in different data stores, and/or the like.

The number and arrangement of components shown in FIG. 4 are provided as an example. In practice, tour management platform 400 may include additional components, fewer components, different components, or differently arranged components than those shown in FIG. 4. Additionally, or alternatively, a set of components (e.g., one or more components) of tour management platform 400 may perform one or more functions described as being performed by another set of components of tour management platform 400.

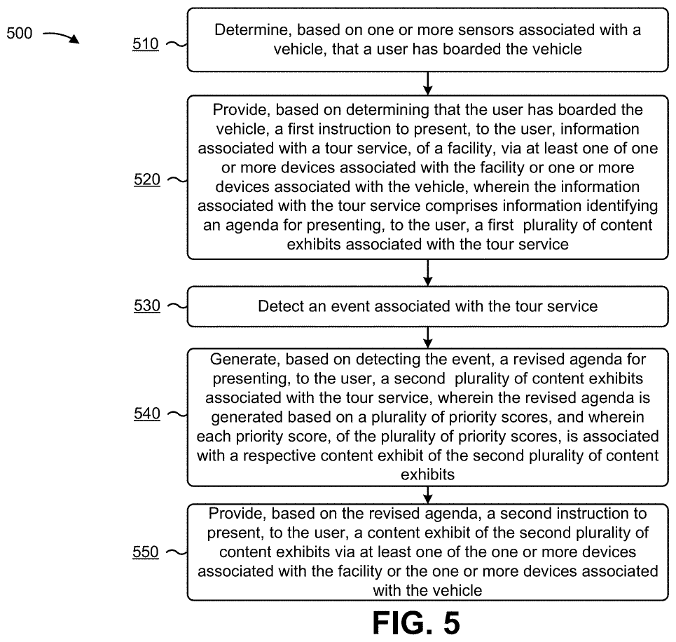

FIG. 5 is a flow chart of an example process 500 for seamless management of connected environments. In some implementations, one or more process blocks of FIG. 5 may be performed by a tour management platform, such as tour management platform 240, tour management platform 400, and/or the like. In some implementations, one or more process blocks of FIG. 5 may be performed by another device or a group of devices separate from or including the tour management platform, such as a user device (e.g., user device 210), a sensor device (e.g., sensor device 220), an I/O device (e.g., I/O device 230), and/or the like.

As shown in FIG. 5, process 500 may include determining, based on one or more sensors associated with a vehicle, that a user has boarded the vehicle (block 510). For example, the tour management platform (e.g., using computing resource 244, processor 320, memory 330, storage component 340, input component 350, output component 360, communication interface 370, and/or the like) may determine, based on one or more sensors associated with a vehicle, that a user has boarded the vehicle, as described above.

As further shown in FIG. 5, process 500 may include providing, based on determining that the user has boarded the vehicle, a first instruction to present, to the user, information associated with a tour service, of a facility, via at least one of one or more devices associated with the facility or one or more devices associated with the vehicle, wherein the information associated with the tour service comprises information identifying an agenda for presenting, to the user, a first plurality of content exhibits associated with the tour service (block 520). For example, the tour management platform (e.g., using computing resource 244, processor 320, memory 330, storage component 340, input component 350, output component 360, communication interface 370, and/or the like) may provide, based on determining that the user has boarded the vehicle, a first instruction to present, to the user, information associated with a tour service, of a facility, via at least one of one or more devices associated with the facility or one or more devices associated with the vehicle, as described above. In some implementations, the information associated with the tour service comprises information identifying an agenda for presenting, to the user, a first plurality of content exhibits associated with the tour service.

As further shown in FIG. 5, process 500 may include detecting an event associated with the tour service (block 530). For example, the tour management platform (e.g., using computing resource 244, processor 320, memory 330, storage component 340, input component 350, output component 360, communication interface 370, and/or the like) may detect an event associated with the tour service, as described above.

As further shown in FIG. 5, process 500 may include generating, based on detecting the event, a revised agenda for presenting, to the user, a second plurality of content exhibits associated with the tour service, wherein the revised agenda is generated based on a plurality of priority scores, and wherein each priority score, of the plurality of priority scores, is associated with a respective content exhibit of the second plurality of content exhibits (block 540). For example, the tour management platform (e.g., using computing resource 244, processor 320, memory 330, storage component 340, input component 350, output component 360, communication interface 370, and/or the like) may generate, based on detecting the event, a revised agenda for presenting, to the user, a second plurality of content exhibits associated with the tour service, as described above. In some implementations, the revised agenda is generated based on a plurality of priority scores. In some implementations, each priority score, of the plurality of priority scores, is associated with a respective content exhibit of the second plurality of content exhibits.

As further shown in FIG. 5, process 500 may include providing, based on the revised agenda, a second instruction to present, to the user, a content exhibit of the second plurality of content exhibits via at least one of the one or more devices associated with the facility or the one or more devices associated with the vehicle (block 550). For example, the tour management platform (e.g., using computing resource 244, processor 320, memory 330, storage component 340, input component 350, output component 360, communication interface 370, and/or the like) may provide, based on the revised agenda, a second instruction to present, to the user, a content exhibit of the second plurality of content exhibits via at least one of the one or more devices associated with the facility or the one or more devices associated with the vehicle, as described above.

Process 500 may include additional implementations, such as any single implementation or any combination of implementations described below and/or in connection with one or more other processes described elsewhere herein.

In some implementations, the event associated with the tour service comprises at least one of a delay in travel of the vehicle to a building included in the facility, a weather event within a threshold distance of the facility, a user input that is received based on the information associated with the tour service that is presented to the user, and/or the like. In some implementations, the user input comprises at least one of an instruction to add a particular content exhibit to the tour service, an instruction to remove a particular content exhibit from the tour service, an instruction to reduce a time duration of the tour service, an instruction to increase the time duration of the tour service, and/or the like.

In some implementations, the second plurality of content exhibits comprises at least one of an audio content exhibit, a two-dimensional video content exhibit, a three-dimensional video content exhibit, a four-dimensional video content exhibit, an augmented reality video content exhibit, a virtual reality video content exhibit, and/or the like. In some implementations, the agenda for presenting the first plurality of content exhibits comprises information specifying a first order in which the first plurality of content exhibits is to be presented to the user, and the revised agenda for presenting the second plurality of content exhibits comprises information specifying a second order in which the second plurality of content exhibits is to be presented to the user, wherein the first order and the second order are different orders.

In some implementations, the tour management platform may present the content exhibit, of the second plurality of content exhibits, via the one or more devices associated with the vehicle, determine that the user has arrived at a building included in the facility, may determine a point in the content exhibit at which the user exited the vehicle, and may provide, based on determining that the user has arrived at the building, a third instruction to present, to the user, the content exhibit via one or more other output devices associated with the building, wherein the presentation of the content exhibit, via the one or more other output devices associated with the building, is to be initiated at the point in the content exhibit at which the user exited the vehicle. In some implementations, the tour management platform may provide, based on the revised agenda, a third instruction to present, to the user and at a building included in the facility, one or more content elements associated with the tour service.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

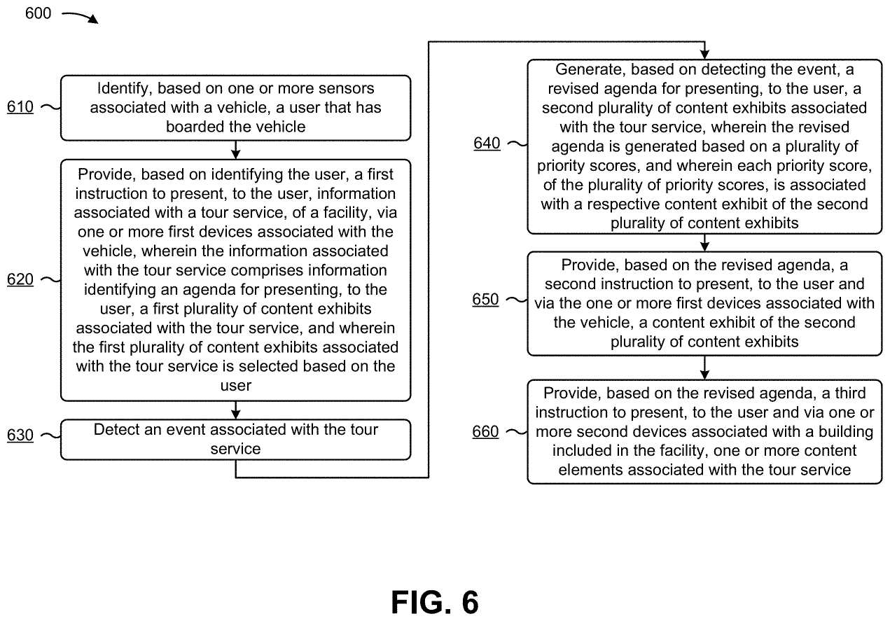

FIG. 6 is a flow chart of an example process 600 for seamless management of connected environments. In some implementations, one or more process blocks of FIG. 6 may be performed by a tour management platform, such as tour management platform 240, tour management platform 400, and/or the like. In some implementations, one or more process blocks of FIG. 6 may be performed by another device or a group of devices separate from or including the tour management platform, such as a user device (e.g., user device 210), a sensor device (e.g., sensor device 220), an I/O device (e.g., I/O device 230), and/or the like.

As shown in FIG. 6, process 600 may include identifying, based on one or more sensors associated with a vehicle, a user that has boarded the vehicle (block 610). For example, the tour management platform (e.g., using computing resource 244, processor 320, memory 330, storage component 340, input component 350, communication interface 370, and/or the like) may identify, based on one or more sensors associated with a vehicle, a user that has boarded the vehicle, as described above.

As further shown in FIG. 6, process 600 may include providing, based on identifying the user, a first instruction to present, to the user, information associated with a tour service, of a facility, via one or more first devices associated with the vehicle, wherein the information associated with the tour service comprises information identifying an agenda for presenting, to the user, a first plurality of content exhibits associated with the tour service, and wherein the first plurality of content exhibits associated with the tour service is selected based on the user (block 620). For example, the tour management platform (e.g., using computing resource 244, processor 320, memory 330, storage component 340, input component 350, output component 360, communication interface 370, and/or the like) may provide, based on identifying the user, a first instruction to present, to the user, information associated with a tour service, of a facility, via one or more first devices associated with the vehicle, as described above. In some implementations, the information associated with the tour service comprises information identifying an agenda for presenting, to the user, a first plurality of content exhibits associated with the tour service. In some implementations, the first plurality of content exhibits associated with the tour service is selected based on the user.

As further shown in FIG. 6, process 600 may include detecting an event associated with the tour service (block 630). For example, the tour management platform (e.g., using computing resource 244, processor 320, memory 330, storage component 340, input component 350, output component 360, communication interface 370, and/or the like) may detect an event associated with the tour service, as described above.

As further shown in FIG. 6, process 600 may include generating, based on detecting the event, a revised agenda for presenting, to the user, a second plurality of content exhibits associated with the tour service, wherein the revised agenda is generated based on a plurality of priority scores, and wherein each priority score, of the plurality of priority scores, is associated with a respective content exhibit of the second plurality of content exhibits (block 640). For example, the tour management platform (e.g., using computing resource 244, processor 320, memory 330, storage component 340, input component 350, output component 360, communication interface 370, and/or the like) may generate, based on detecting the event, a revised agenda for presenting, to the user, a second plurality of content exhibits associated with the tour service, as described above. In some implementations, the revised agenda is generated based on a plurality of priority scores. In some implementations, each priority score, of the plurality of priority scores, is associated with a respective content exhibit of the second plurality of content exhibits.

As further shown in FIG. 6, process 600 may include providing, based on the revised agenda, a second instruction to present, to the user and via the one or more first devices associated with the vehicle, a content exhibit of the second plurality of content exhibits (block 650). For example, the tour management platform (e.g., using computing resource 244, processor 320, memory 330, storage component 340, input component 350, output component 360, communication interface 370, and/or the like) may provide, based on the revised agenda, a second instruction to present, to the user and via the one or more first devices associated with the vehicle, a content exhibit of the second plurality of content exhibits, as described above.

As further shown in FIG. 6, process 600 may include providing, based on the revised agenda, a third instruction to present, to the user and via one or more second devices associated with a building included in the facility, one or more content elements associated with the tour service (block 660). For example, the tour management platform (e.g., using computing resource 244, processor 320, memory 330, storage component 340, input component 350, output component 360, communication interface 370, and/or the like) may provide, based on the revised agenda, a third instruction to present, to the user and via one or more second devices associated with a building included in the facility, one or more content elements associated with the tour service, as described above.

Process 600 may include additional implementations, such as any single implementation or any combination of implementations described below and/or in connection with one or more other processes described elsewhere herein.

In some implementations, when generating the revised agenda for presenting the second plurality of content exhibits associated with the tour service, the tour management platform may generate the revised agenda based on at least one of an estimated time of arrival of the vehicle at the building included in the facility, a weather event within a threshold distance the facility, an expected time duration of a transit of the vehicle from the building, included in the facility, to another building included in the facility, and/or the like. In some implementations, a priority score associated with the respective content exhibit, of the plurality of priority scores associated with the second plurality of content exhibits, is determined based on at least one of a user input specifying a preference for the respective content exhibit; feedback received from the user, based on the user viewing the respective content exhibit in another tour service; an analysis of emotions exhibited by the user as the user viewed the respective content exhibit in the other tour service; relevance of the respective content exhibit to an attribute associated with the user; feedback received from one or more other users that were presented the respective content exhibit; an amount of time the one or more other users spent viewing the respective content exhibit, and/or the like.

In some implementations, the content exhibit is a first content exhibit, the second plurality of content exhibits comprises either a second content exhibit that is not included in the first plurality of content exhibits or a third content exhibit that is to be presented in a different format in the tour service, and the first plurality of content exhibits comprises a fourth content exhibit that is not included in the second plurality of content exhibits. In some implementations, the content exhibit is a first content exhibit, and the second plurality of content exhibits comprises either a second content exhibit having a reduced time duration in the tour service or a third content exhibit having an increased time duration in the tour service.

In some implementations, the tour management platform may provide, based on the revised agenda, a fourth instruction to present, to the user and via the one or more second devices associated with the building included in the facility, the content exhibit of the second plurality of content exhibits. In some implementations, the one or more content elements comprises an electronic display of the revised agenda and/or an electronic display of one or more directions, at the building, associated with the content exhibit, and/or the like.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

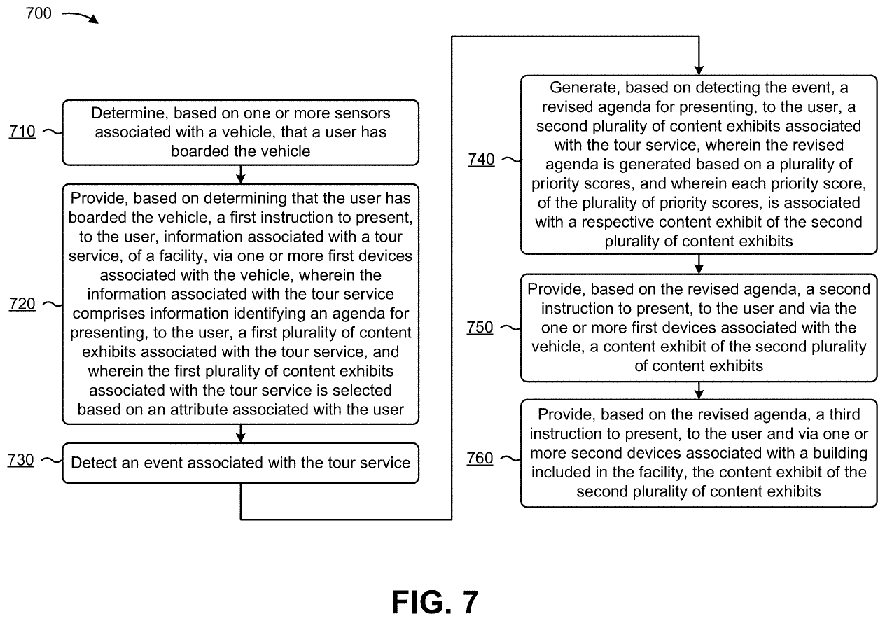

FIG. 7 is a flow chart of an example process 700 for seamless management of connected environments. In some implementations, one or more process blocks of FIG. 7 may be performed by a tour management platform, such as tour management platform 240, tour management platform 400, and/or the like. In some implementations, one or more process blocks of FIG. 7 may be performed by another device or a group of devices separate from or including the tour management platform, such as a user device (e.g., user device 210), a sensor device (e.g., sensor device 220), an I/O device (e.g., I/O device 230), and/or the like.

As shown in FIG. 7, process 700 may include determining, based on one or more sensors associated with a vehicle, that a user has boarded the vehicle (block 710). For example, the tour management platform (e.g., using computing resource 244, processor 320, memory 330, storage component 340, input component 350, communication interface 370, and/or the like) may determine, based on one or more sensors associated with a vehicle, that a user has boarded the vehicle, as described above.

As further shown in FIG. 7, process 700 may include providing, based on determining that the user has boarded the vehicle, a first instruction to present, to the user, information associated with a tour service, of a facility, via one or more first devices associated with the vehicle, wherein the information associated with the tour service comprises information identifying an agenda for presenting, to the user, a first plurality of content exhibits associated with the tour service, and wherein the first plurality of content exhibits associated with the tour service is selected based on an attribute associated with the user (block 720). For example, the tour management platform (e.g., using computing resource 244, processor 320, memory 330, storage component 340, input component 350, output component 360, communication interface 370, and/or the like) may provide, based on determining that the user has boarded the vehicle, a first instruction to present, to the user, information associated with a tour service, of a facility, via one or more first devices associated with the vehicle, as described above. In some implementations, the information associated with the tour service comprises information identifying an agenda for presenting, to the user, a first plurality of content exhibits associated with the tour service. In some implementations, the first plurality of content exhibits associated with the tour service is selected based on an attribute associated with the user.

As further shown in FIG. 7, process 700 may include detecting an event associated with the tour service (block 730). For example, the tour management platform (e.g., using computing resource 244, processor 320, memory 330, storage component 340, input component 350, output component 360, communication interface 370, and/or the like) may detect an event associated with the tour service, as described above.

As further shown in FIG. 7, process 700 may include generating, based on detecting the event, a revised agenda for presenting, to the user, a second plurality of content exhibits associated with the tour service, wherein the revised agenda is generated based on a plurality of priority scores, and wherein each priority score, of the plurality of priority scores, is associated with a respective content exhibit of the second plurality of content exhibits (block 740). For example, the tour management platform (e.g., using computing resource 244, processor 320, memory 330, storage component 340, input component 350, output component 360, communication interface 370, and/or the like) may generate, based on detecting the event, a revised agenda for presenting, to the user, a second plurality of content exhibits associated with the tour service, as described above. In some implementations, the revised agenda is generated based on a plurality of priority scores. In some implementations, each priority score, of the plurality of priority scores, is associated with a respective content exhibit of the second plurality of content exhibits.

As further shown in FIG. 7, process 700 may include providing, based on the revised agenda, a second instruction to present, to the user and via the one or more first devices associated with the vehicle, a content exhibit of the second plurality of content exhibits (block 750). For example, the tour management platform (e.g., using computing resource 244, processor 320, memory 330, storage component 340, input component 350, output component 360, communication interface 370, and/or the like) may provide, based on the revised agenda, a second instruction to present, to the user and via the one or more first devices associated with the vehicle, a content exhibit of the second plurality of content exhibits, as described above.

As further shown in FIG. 7, process 700 may include providing, based on the revised agenda, a third instruction to present, to the user and via one or more second devices associated with a building included in the facility, the content exhibit of the second plurality of content exhibits (block 760). For example, the tour management platform (e.g., using computing resource 244, processor 320, memory 330, storage component 340, input component 350, output component 360, communication interface 370, and/or the like) may provide, based on the revised agenda, a third instruction to present, to the user and via one or more second devices associated with a building included in the facility, the content exhibit of the second plurality of content exhibits, as described above.

Process 700 may include additional implementations, such as any single implementation or any combination of implementations described below and/or in connection with one or more other processes described elsewhere herein.

In some implementations, the second plurality of content exhibits comprises at least one of an interactive augmented reality content exhibit, an interactive virtual reality content exhibit, a live presenter-led content exhibit, an interactive live content exhibit, a web-based content exhibit, and/or the like. In some implementations, the event associated with the tour service comprises a user input that is received based on the information associated with the tour service that is presented to the user, and the user input comprises at least one of a fourth instruction to reduce a time duration of the content exhibit in the tour service, a fifth instruction to increase the time duration of the content exhibit in the tour service, a sixth instruction to reorder the first plurality of content exhibits in the tour service, and/or the like.

In some implementations, a priority score, of the plurality of priority scores, associated with the respective content exhibit, of the second plurality of content exhibits, is determined based on at least one of a first quantity of other users, associated with the attribute that is associated with the user, who expressed an interest in viewing the respective content exhibit; a second quantity of other users, associated with the attribute that is associated with the user, who have viewed the respective content exhibit, and/or the like.

In some implementations, the agenda for presenting the first plurality of content exhibits comprises information specifying that another content exhibit is to be presented to the user via the one or more first devices associated with the vehicle, and the revised agenda for presenting the second plurality of content exhibits comprises information specifying that the other content exhibit is to be presented to the user via the one or more second devices associated with the building included in the facility. In some implementations, the tour management platform may provide, based on the revised agenda, a fourth instruction to present, to the user and via one or more third devices associated with the facility, one or more content elements associated with the tour service.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A tour management platform, comprising:
one or more memories; and
one or more processors, communicatively coupled to the one or more memories, to:
determine, based on one or more sensors associated with a vehicle, that a user has boarded the vehicle;
provide, based on determining that the user has boarded the vehicle, a first instruction to present, to the user, information associated with a tour service, of a facility, via at least one of:
one or more devices associated with the facility, or
one or more devices associated with the vehicle,
wherein the information associated with the tour service comprises:
information identifying an agenda for presenting, to the user, a first plurality of content exhibits associated with the tour service;
detect an event associated with the tour service;
generate, based on detecting the event, a revised agenda for presenting, to the user, a second plurality of content exhibits associated with the tour service,
wherein the revised agenda is generated based on a plurality of priority scores, and
wherein each priority score, of the plurality of priority scores, is associated with a respective content exhibit of the second plurality of content exhibits; and
provide, based on the revised agenda, a second instruction to present, to the user, a content exhibit of the second plurality of content exhibits via at least one of:
the one or more devices associated with the facility, or
the one or more devices associated with the vehicle.

2. The tour management platform of claim 1, wherein the event associated with the tour service comprises at least one of:
a delay in travel of the vehicle to a building included in the facility,
a weather event within a threshold distance of the facility, or
a user input that is received based on the information, associated with the tour service, presented to the user.

3. The tour management platform of claim 2, wherein the user input comprises at least one of:
an instruction to add a particular content exhibit to the tour service,
an instruction to remove a particular content exhibit from the tour service,
an instruction to reduce a time duration of the tour service, or
an instruction to increase the time duration of the tour service.

4. The tour management platform of claim 1, wherein the second plurality of content exhibits comprises at least one of:
an audio content exhibit,
a two-dimensional video content exhibit,
a three-dimensional video content exhibit,
a four-dimensional video content exhibit,
an augmented reality video content exhibit,
a virtual reality video content exhibit.

5. The tour management platform of claim 1, wherein the agenda for presenting the first plurality of content exhibits comprises:
information specifying a first order in which the first plurality of content exhibits is to be presented to the user; and
wherein the revised agenda for presenting the second plurality of content exhibits comprises:
information specifying a second order in which the second plurality of content exhibits is to be presented to the user,
wherein the first order and the second order are different orders.

6. The tour management platform of claim 1, wherein the one or more processors, when providing the second instruction to present the content exhibit, of the second plurality of content exhibits, via at least one of the one or more devices associated with the facility or the one or more devices associated with the vehicle, are to:
present the content exhibit, of the second plurality of content exhibits, via the one or more devices associated with the vehicle; and
wherein the one or more processors are further to:
determine that the user has arrived at a building included in the facility;
determine a point in the content exhibit at which the user exited the vehicle; and
provide, based on determining that the user has arrived at the building, a third instruction to present, to the user, the content exhibit via one or more other output devices associated with the building,
wherein the presentation of the content exhibit, via the one or more other output devices associated with the building, is to be initiated at the point in the content exhibit at which the user exited the vehicle.

7. The tour management platform of claim 1, wherein the one or more processors are further to:
provide, based on the revised agenda, a third instruction to present, to the user and at a building included in the facility, one or more content elements associated with the tour service.

8. A non-transitory computer-readable medium storing instructions, the instructions comprising:
one or more instructions that, when executed by one or more processors of a tour management platform, cause the one or more processors to:
identify, based on one or more sensors associated with a vehicle, a user that has boarded the vehicle;
provide, based on identifying the user, a first instruction to present, to the user, information associated with a tour service of a facility, via one or more first devices associated with the vehicle,
wherein the information associated with the tour service comprises:
information identifying an agenda for presenting, to the user, a first plurality of content exhibits associated with the tour service, and
wherein the first plurality of content exhibits associated with the tour service is selected based on the user;
detect an event associated with the tour service;
generate, based on detecting the event, a revised agenda for presenting, to the user, a second plurality of content exhibits associated with the tour service,
wherein the revised agenda is generated based on a plurality of priority scores, and
wherein each priority score, of the plurality of priority scores, is associated with a respective content exhibit of the second plurality of content exhibits;
provide, based on the revised agenda, a second instruction to present, to the user and via the one or more first devices associated with the vehicle, a content exhibit of the second plurality of content exhibits; and
provide, based on the revised agenda, a third instruction to present, to the user and via one or more second devices associated with a building included in the facility, one or more content elements associated with the tour service.

9. The non-transitory computer-readable medium of claim 8, wherein the one or more instructions, that cause the one or more processors to generate the revised agenda for presenting the second plurality of content exhibits associated with the tour service, cause the one or more processors to:
generate the revised agenda based on at least one of:
an estimated time of arrival of the vehicle at the building included in the facility,
a weather event within a threshold distance the facility, or
an expected time duration of a transit of the vehicle from the building, included in the facility, to another building included in the facility.

10. The non-transitory computer-readable medium of claim 8, wherein a priority score, of the plurality of priority scores, associated with the respective content exhibit, of the second plurality of content exhibits, is determined based on at least one of:
a user input specifying a preference for the respective content exhibit,
feedback received from the user based on the user viewing the respective content exhibit in another tour service,
an analysis of emotions exhibited by the user as the user viewed the respective content exhibit in the other tour service,
relevance of the respective content exhibit to an attribute associated with the user,
feedback received from one or more other users that were presented the respective content exhibit, or
an amount of time the one or more other users spent viewing the respective content exhibit.

11. The non-transitory computer-readable medium of claim 8, wherein the content exhibit is a first content exhibit;
wherein the second plurality of content exhibits comprises:
a second content exhibit that is not included in the first plurality of content exhibits, or
a third content exhibit that is to be presented in a different format in the tour service; and
wherein the first plurality of content exhibits comprises:
a fourth content exhibit that is not included in the second plurality of content exhibits.

12. The non-transitory computer-readable medium of claim 8, wherein the content exhibit is a first content exhibit;
wherein the second plurality of content exhibits comprises:
a second content exhibit having a reduced time duration in the tour service, or
a third content exhibit having an increased time duration in the tour service.

13. The non-transitory computer-readable medium of claim 8, wherein the one or more instructions, when executed by the one or more processors, further cause the one or more processors to:
provide, based on the revised agenda, a fourth instruction to present, to the user and via the one or more second devices associated with the building included in the facility, the content exhibit of the second plurality of content exhibits.

14. The non-transitory computer-readable medium of claim 8, wherein the one or more content elements comprises:
an electronic display of the revised agenda, or
an electronic display of one or more directions, at the building, associated with the content exhibit.

15. A method, comprising:
determining, by a tour management platform and based on one or more sensors associated with a vehicle, that a user has boarded the vehicle;
providing, by the tour management platform and based on determining that the user has boarded the vehicle, a first instruction to present, to the user, information associated with a tour service, of a facility, via one or more first devices associated with the vehicle,
wherein the information associated with the tour service comprises:
information identifying an agenda for presenting, to the user, a first plurality of content exhibits associated with the tour service, and
wherein the first plurality of content exhibits associated with the tour service is selected based on an attribute associated with the user;
detecting, by the tour management platform, an event associated with the tour service;
generating, by the tour management platform and based on detecting the event, a revised agenda for presenting, to the user, a second plurality of content exhibits associated with the tour service,
wherein the revised agenda is generated based on a plurality of priority scores, and
wherein each priority score, of the plurality of priority scores, is associated with a respective content exhibit of the second plurality of content exhibits;
providing, by the tour management platform and based on the revised agenda, a second instruction to present, to the user and via the one or more first devices associated with the vehicle, a content exhibit of the second plurality of content exhibits; and
providing, by the tour management platform and based on the revised agenda, a third instruction to present, to the user and via one or more second devices associated with a building included in the facility, the content exhibit of the second plurality of content exhibits.

16. The method of claim 15, wherein the second plurality of content exhibits comprises at least one of:
an interactive augmented reality content exhibit,
an interactive virtual reality content exhibit,
a live presenter-led content exhibit,
an interactive live content exhibit, or
a web-based content exhibit.

17. The method of claim 15, wherein the event associated with the tour service comprises:
a user input that is received based on the information, associated with the tour service, presented to the user,
wherein the user input comprises at least one of:
a fourth instruction to reduce a time duration of the content exhibit in the tour service,
a fifth instruction to increase the time duration of the content exhibit in the tour service, or
a sixth instruction to reorder the first plurality of content exhibits in the tour service.

18. The method of claim 15, wherein a priority score, of the plurality of priority scores, associated with the respective content exhibit, of the second plurality of content exhibits, is determined based on at least one of:
a first quantity of other users, associated with the attribute that is associated with the user, that expressed an interest in viewing the respective content exhibit, or
a second quantity of other users, associated with the attribute that is associated with the user, that have viewed the respective content exhibit.

19. The method of claim 15, wherein the agenda for presenting the first plurality of content exhibits comprises:
information specifying that another content exhibit is to be presented to the user via the one or more first devices associated with the vehicle; and
wherein the revised agenda for presenting the second plurality of content exhibits comprises:
information specifying that the other content exhibit is to be presented to the user via the one or more second devices associated with the building included in the facility.

20. The method of claim 15, further comprising:
providing, based on the revised agenda, a fourth instruction to present, to the user and via one or more third devices associated with the facility, one or more content elements associated with the tour service.
